(19) United States
(12) Patent Application Publication
(10) Pub. No.: US 2008/0152410 A1
(43) Pub. Date: Jun. 26, 2008

(54) DRIVEN ROTARY UNIT FOR CONVEYING A SHEET, SHEET CONVEYING DEVICE, AND IMAGE FORMING APPARATUS

(75) Inventors: Takeshi FUKUDA, Nagareyama-shi (JP); Shigeru WATANABE, Saitama-shi (JP); Yasutaka GOTOH, Saitama-shi (JP); Kiichirou ARIKAWA, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD, Tokyo (JP)

(21) Appl. No.: 11/782,913

(22) Filed: Jul. 25, 2007

(30) Foreign Application Priority Data
Dec. 20, 2006 (JP) 2006-342595

(51) Int. Cl. G03G 15/16

(52) U.S. Cl. 399/409

(57) ABSTRACT

A driven rotary unit for conveying a sheet, includes a shaft member which is rotatably supported by a supporting member, and a cylindrical cylinder member which is attached to an outside of the shaft member, in which an inner diameter of the cylinder member is larger than an outer diameter of the shaft member, and which is disposed to be freely rotatable with respect to the shaft member, wherein the driven rotary unit is rotated by a conveyed sheet.

### CROSS-REFERENCE TO RELATED APPLICATIONS

This application is based on and claims priority under 35 USC 119 from Japanese Patent Application No. 2006-342595 filed on Dec.20, 2006.

### BACKGROUND

1. Technical Field

The present invention relates to a driven rotary unit for conveying a sheet, a sheet conveying device, and an image forming apparatus.

2. Related Art

In an image forming apparatus such as a printer, a copier, or a facsimile apparatus, for example, sheet conveying rollers (sheet conveying devices) having various configurations are adequately placed in order to convey a sheet on which an image is to be recorded.

A usual sheet conveying roller is configured by a driving roller (driving rotary unit) and a driven roller (driven rotary unit) which are in pressing contact with each other, so that the driven roller is drivenly rotated by a rotational force of the driving roller. The driving roller and the driven roller are rotated while nipping a sheet therebetween by a pressure contact force, whereby a rotational force of the rollers is transmitted to the sheet to convey the sheet in a predetermined direction.

In order to reduce the cost of the shaft of the driven roller or a member (supporting member) supporting the shaft, it may be contemplated that the shaft is made of a material having a high sliding property, namely a highly slidable material, thereby simplifying the structure for supporting the shaft.

In the case where the shaft supporting structure is simplified, when the rotational speed of the roller is raised in order to increase the sheet conveying speed, however, the wear and heat resistant properties corresponding to the high-speed rotation cannot be obtained, and the life of the driven roller is shortened.

In order to avoid the shortening of the life, eventually, an expensive material having high wear and heat resistant properties must be selected as the material of the driven roller.

### SUMMARY

According to an aspect of the invention, there is provided a driven rotary unit for conveying a sheet, including: a shaft member which is rotatably supported by a supporting member; and a cylindrical cylinder member which is attached to an outside of the shaft member, in which an inner diameter of the cylinder member is larger than an outer diameter of the shaft member, and which is disposed to be freely rotatable with respect to the shaft member, wherein the driven rotary unit is rotated by a conveyed sheet.

### BRIEF DESCRIPTION OF THE DRAWINGS

Exemplary embodiments of the present invention will be described in detail based on the following figures, wherein:

FIG. 1 is a diagram showing an image forming apparatus which is an exemplary embodiment of the invention;

FIG. 2 is a diagram showing a fixing device disposed in the image forming apparatus of FIG. 1;

FIG. 3 is a perspective view showing a sheet conveying roller attached to the fixing device of FIG. 2;

FIG. 4 is a perspective view showing a driven roller constituting the sheet conveying roller of FIG. 3;

FIG. 5 is a perspective view showing a state where the driven roller of FIG. 4 is attached to the fixing device;

FIG. 6 is a diagram showing an example of a positional relationship between driving and driven rollers constituting a sheet conveying roller;

FIG. 7 is a diagram showing another example of a positional relationship between driving and driven rollers constituting a sheet conveying roller; and

FIG. 8 is a diagram showing an image forming apparatus which is another exemplary embodiment of the invention,

wherein 25 denotes fixing device, 50 denotes housing, 50a denotes lid, 50b denotes supporting portion, 52 denotes heating roller, 53 denotes pressing roller, 54 denotes driving roller (driving rotary unit), 54a denotes shaft, 54b denotes gear, 54c denotes roller body (body portion), 55 denotes driven roller (driven rotary unit), 55a denotes shaft member, 55aa denotes holding portion, 55ab denotes supported portion, 55b denotes cylinder member, 55ba denotes cutaway portion, 55baa denotes tip end, 56 denotes sheet conveying roller (sheet conveying device), 57 denotes torsion spring (elastic member), 61 denotes driving system, D denotes sheet conveying direction, P denotes fixing station, S denotes sheet, W1 denotes width, and W2 denotes width.

### DETAILED DESCRIPTION

Hereinafter, an exemplary embodiment of the invention will be described in detail with reference to the accompanying drawings. In the drawings illustrating the exemplary embodiment, the identical components are denoted by the same reference numerals, and repeated description will be omitted.

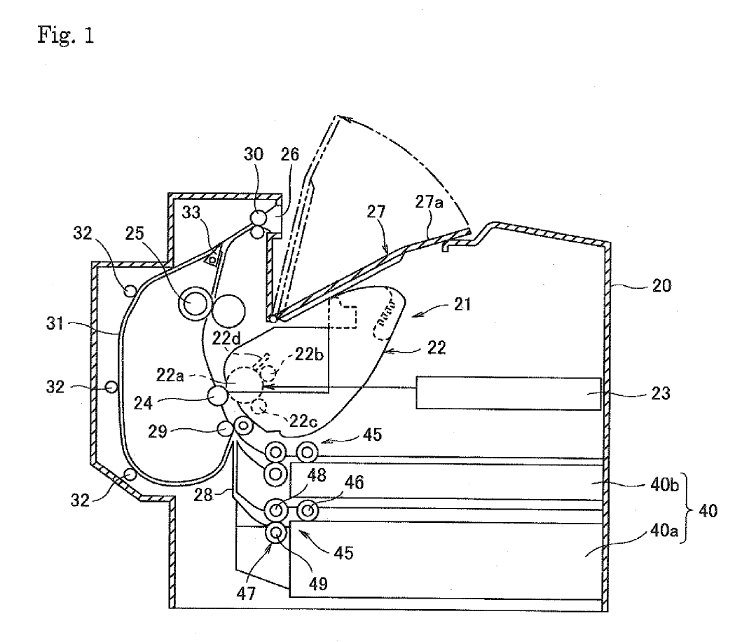

Referring to FIG. 1, in an image forming apparatus, for example, an image forming engine 21 of the electrophotographic type is mounted in the apparatus body 20. A sheet feeding device 40 of the drawer type is placed to be housed below the image forming engine 21. A discharge tray 27 is formed in an upper portion of the apparatus body 20, and a sheet conveying path 28 is formed inside the apparatus body 20 in a substantially vertical direction. The sheet conveying path guides a sheet such as a paper sheet fed from the sheet feeding device 40, from a discharge port 26 to the discharge tray 27 via the image forming engine 21.

In the exemplary embodiment, the sheet feeding device 40 has a two-stage configuration in the apparatus body 20 (specifically, a sheet feeding device 40a which is positioned in a lower side, and a sheet feeding device 40b which is positioned in an upper side). However, the sheet feeding device is not restricted to this, and may have a single-stage configuration or a three- or more-stage configuration.

In the exemplary embodiment, the image forming engine 21 uses a process cartridge 22 in which plural devices of the electrophotographic system are integrated with one another. The process cartridge 22 includes: a photosensitive drum 22a which functions as an image carrier; a charging device 22b which charges the photosensitive drum 22a; a developing device 22c which develops an electrostatic latent image formed on the photosensitive drum 22a, into a visible image by a toner; and a cleaning device 22d which removes away a residual toner on the photosensitive drum 22a. The process cartridge 22 is attachable and detachable through a tray cover 27a which is openably and closably disposed in the discharge tray 27.

The mage forming engine 21 further includes: an exposing device 23 which optically writes an electrostatic latent image onto the photosensitive drum 22a that is uniformly charged to a predetermined potential by the charging device 22b, and which is configured by, for example, a laser scanning device; a transfer roller 24 which transfers a toner image formed on the photosensitive drum 22a to the sheet; and a fixing device 25 which performs thermocompression bonding on the toner image that is transferred by the transfer roller 24, to fix the toner image onto the sheet.

In the exemplary embodiment, in the sheet conveying path 28, a registration roller 29 for positioning and conveying the sheet is placed upstream of the photosensitive drum 22a, and a discharge roller 30 is placed in the vicinity of the discharge port 26 in the sheet conveying path 28.

Also the photosensitive drum 22a, transfer roller 24, and fixing device 25 which are opposed to the sheet conveying path 28 function as unit for conveying the sheet.

Therefore, a sheet fed from the sheet feeding device 40 is positioned by the registration roller 29 of the sheet conveying path 28, sent to an image transfer station of the process cartridge 22 at a predetermined timing to be subjected to image transfer, and thereafter discharged from the discharge port 26 to the discharge tray 27 via the fixing device 25.

In the image forming apparatus of the exemplary embodiment, an inversion path 31 is formed so that, in the two-sided recording mode, a sheet in which an image has been formed on one face is returned to the inversion path 31. Specifically, the sheet conveying path 28 branches off into two paths in a portion which is in front of the discharge roller 30, a switch gate 33 is disposed in the branching portion, and the inversion path 31 is formed so as to return from the branching portion to the registration roller 29.

Conveying rollers 32 are adequately placed in the inversion path 31. In the two-sided recording mode, the switch gate 33 is switched to a side where the inversion path 31 is opened, and the discharge roller 30 is reversely rotated at a timing when a portion in front of the rear end of a sheet reaches the discharge roller 30, to guide the sheet into the inversion path 31. Thereafter, the inverted sheet passes the registration roller 29, the portion between the photosensitive drum 22a and the transfer roller 24, and the fixing device 25, and then is guided to the discharge tray 27 via the fixing device 25.

A sheet feed-out unit 45 is disposed above the sheet feeding device 40 on the side of the sheet feeding direction.

The sheet feed-out unit 45 includes: a pickup roller 46 which is contactingly placed on a sheet positioned in the uppermost portion of sheets stacked in the sheet feeding device 40, to feed out the sheet; and a separating mechanism 47 which separates the sheets fed out by the pickup roller 46, from one another.

The separating mechanism 47 is configured by a feed roller 48 which feeds a sheet toward the sheet conveying path 28, and a separation roller 49 which is in pressing contact with the feed roller 48 to be rotated therewith, and to which a predetermined rotation blocking force is given.

The pickup roller 46 is rotatably attached to a free-end side of a swing plate (not shown) which is swingable with setting the rotation axis of the feed roller 48 as a swinging point. An urging force which is downward directed is given by a spring to the swing plate, so that the pickup roller 46 is pressed against the uppermost sheet by a predetermined force.

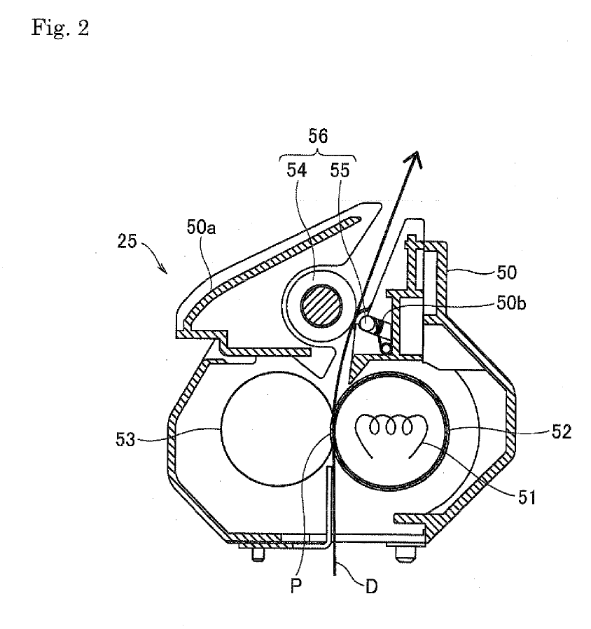

As shown in FIG. 2, the fixing device 25 includes: a heating roller 52 which is disposed in a housing 50, which is rotated by a rotational force of rotation driving unit (not shown), and in which a heating source 51 such as a halogen lamp is attached; and a pressing roller 53 which is in pressing contact with the heating roller 52 to be drivenly rotated.

When a sheet which has been sent to the image transfer station of the process cartridge 22, and to which a toner image has been transferred passes a fixing station P where the heating roller 52 and the pressing roller 53 are in pressing contact with each other, in a sheet conveying direction D, heat and a pressure bonding force are applied to the sheet, whereby the toner images is fixed to the sheet.

A sheet conveying roller (sheet conveying device) 56 for conveying the sheet to which the toner image has been fixed is placed downstream of the fixing station P of the fixing device 25 in the sheet conveying direction D.

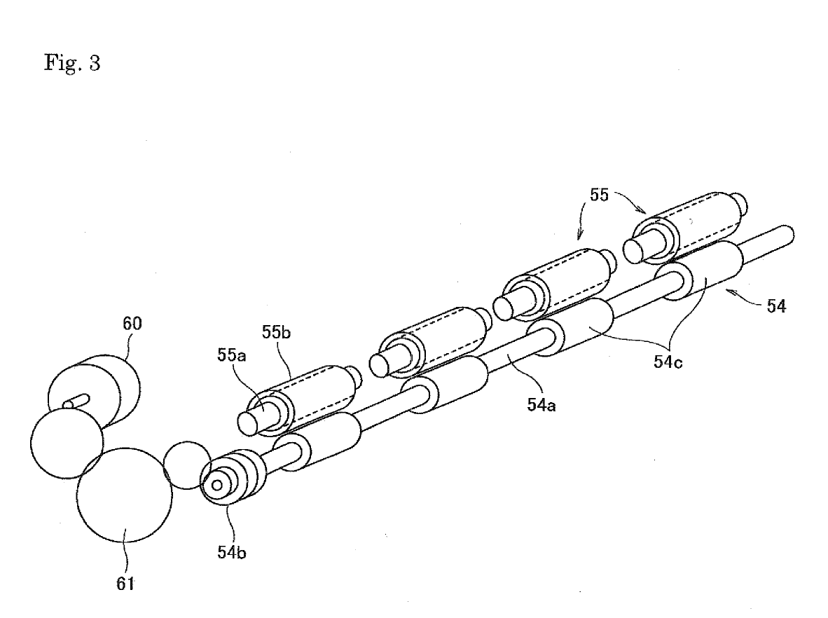

As shown in FIG. 3, the sheet conveying roller 56 is configured by: a driving roller (driving rotary unit) 54 which is rotated by a rotational force of an electric motor (rotary driving source) 60 and transmitted via a driving system 61 configured by a gear train or the like; and driven rollers (driven rotary units) 55 which are in pressing contact with the driving roller 54 to be drivenly rotated.

The driving roller 54 is configured by: a shaft 54a in which a gear 54b meshing with the driving system 61 is attached to one end portion, and which is rotatably supported by a bearing (not shown); and cylindrical roller bodies (body portions) 54c which are attached to the shaft 54a at predetermined intervals, and which are made of rubber. The driving roller 54 is attached to the inside of a lid 50a which is openably and closably mounted on the housing 50, and which is used for maintenance and the like. When the lid 50a is closed, the gear 54b meshes with the driving system 61, and the driving roller 54 is pressingly contacted with the driven rollers 55.

In the exemplary embodiment, as shown in FIG. 3, plural driven rollers 55 are separately disposed in respective correspondence to the roller bodies 54c of the driving roller 54, and arranged on the same axis.

As shown in FIG. 4, each of the driven rollers 55 is configured by a shaft member 55a which is rotatably supported by a supporting portion (supporting member) 50b (FIG. 3) formed in the housing 50, and a cylindrical cylinder member 55b which is fitted onto the outside of the shaft member. The inner diameter of the cylinder member 55b is larger than the outer diameter of the shaft member 55a, thereby allowing the cylinder member 55b to be freely rotatable with respect to the shaft member 55a. The term of freely rotatable means that the shaft member 55a and the cylinder member 55b are independently relatively rotatable.

The shaft member 55a is configured by: a columnar holding portion 55aa into which the cylinder member 55b is fitted, and which holds the cylinder member; and a supported portion 55ab which is coaxial with the rotation axis of the holding portion 55aa on the both sides in the axial direction of the holding portion 55aa, and which is formed to be smaller in diameter than the holding portion 55aa. The supported portion 55ab is rotatably supported by the supporting portion 50b. In relation to the cylinder member 55b, the inner diameter of the cylinder member 55b is larger than the outer diameter of the holding portion 55aa.

The driven roller 55 is drivenly rotated by transmitting the rotational force of the driving roller 54 to the cylinder member 55b, to cooperate with the driving roller 54 to convey the sheet.

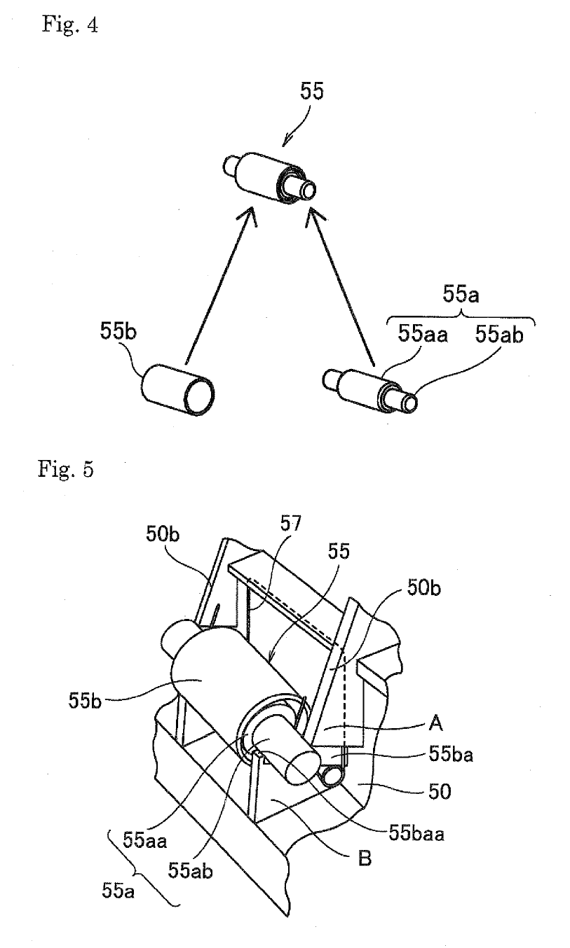

Referring to FIG. 5, the supporting portion 50b consists of a pair of projection pieces which are integrally formed on the housing 50 with forming a gap that is larger than the width of the holding portion 55aa. In each of the projection pieces, a cutaway portion 55ba into which the supported portion 55ab is rotatably fitted is formed so as to extend in the approaching/separating direction of the driving roller 54. In the cutaway portion 55ba, only the width of a tip end 55baa is slightly smaller than the diameter of the supported portion 55ab. When the driven roller 55 is pressed into the supporting portion 50b, therefore, the tip ends 55baa are elastically deformed, and the supported portion 55ab is fitted into the cutaway portions 55ba, so that the supported portion does not drop off from the cutaway portions 55ba unless an external force is applied.

In both of the pair of projection pieces of the supporting portion 50b, two portions A and B across the cutaway portion 55ba are shifted in the width direction from each other by a dimension which is slightly larger the width of the projection piece. A torsion spring (elastic member) 57 which urges (the supported portion 55ab in the two places of) the shaft member 55a of the driven roller 55 toward the driving roller 54 to generate a pressure contact force between the driven roller 55 and the driving roller 54 is attached so as to be fitted into the shifted dimension. As described above, when the lid 50a is closed, the driving roller 54 is pressingly contacted with the driven rollers 55. This is caused by an operation in which the driven roller 55 is retracted by the driving roller 54 against the elastic force of the torsion spring 57.

Alternatively, a member (for example, a coil spring or a plate spring) other than the torsion spring 57 may be used as the elastic member.

In the exemplary embodiment, the cylinder member 55b is formed by a fluororesin from the viewpoints that the sliding property with respect to the shaft member 55a is improved, and that toner contamination is prevented from occurring. The shaft member 55a is made of a resin (for example, polypropylene or styrene) or a corrosion-resistant metal (SUS, stainless steel, or plating such as zinc plating) from the viewpoint that deterioration due to corrosion is prevented from occurring. However, the cylinder member 55b and the shaft member 55a are not necessarily configured as described above.

In the thus configured sheet conveying roller 56, the driving roller 54 and the driven roller 55 are rotated while nipping a sheet by the pressure contact force, whereby the rotational force of the rollers 54, 55 is transmitted to the sheet to move the sheet in the sheet conveying direction D.

The driven roller 55 of the exemplary embodiment is configured by the shaft member 55a which is rotatably supported by the supporting portion 50b, and the cylindrical cylinder member 55b which is fitted onto the outside of the shaft member 55a so as to be freely rotatable. Therefore, the cylinder member 55b is rotated by the rotational force of the driving roller 54, but the shaft member 55a is slid so as to be pulled by the rotation of the cylinder member 55b, so that the transmission efficiency of the rotational force of the cylinder member 55b with respect to the shaft member 55a is lowered.

Therefore, the shaft member 55a is rotated at a rotation number lower than that of the cylinder member 55b, and the total rotation number of the shaft member is reduced as compared with that of the cylinder member 55b. As a result, as compared with the case where the shaft member 55a and the cylinder member 55b are integrally rotated, the amount of wear between the shaft member 55a and the supporting portion 50b due to the rotation of the shaft member 55a is reduced, and the thermal deterioration rate is lowered. Since the amount of wear between the shaft member 55a and the supporting portion 50b is reduced, the importance of the wear and sliding properties with respect to the shaft member 55a are relatively lowered. Therefore, an economical material can be selected as the shaft member 55a. Consequently, the frictional heat is less generated. Even when the sheet conveying device is disposed downstream of the fixing device 25, an economical material which has a low heat resistance can be selected.

In this way, the rotation number of the shaft member 55a is lowered as compared with that of the cylinder member, and hence the amount of wear between the torsion spring 57 and the shaft member 55a is reduced, so that mechanical stresses of the two members can be reduced.

As described above, the cylinder member 55b is formed by a fluororesin. Therefore, a toner on the sheet hardly adheres to the outer peripheral surface, and contamination due to the toner can be prevented from occurring. With respect to the inner peripheral surface, the sliding property against the shaft member 55a is improved (namely, the members easily slide), and the transmission efficiency of the rotational force of the cylinder member 55b with respect to the shaft member 55a is further lowered. Consequently, the rotation number of the shaft member 55a is further lowered, and the amount of wear with respect to the supporting portion 50b due to the rotation of the shaft member 55a, and the thermal deterioration rate are further reduced.

Also when the inner and outer peripheral surfaces of the shaft member 55a are coated with a fluororesin, toner contamination can be avoided, and the sliding property against the shaft member 55a can be improved. It is not necessary to coat both the inner and outer peripheral surfaces with a fluororesin, and only one of the surfaces may be coated with a fluororesin.

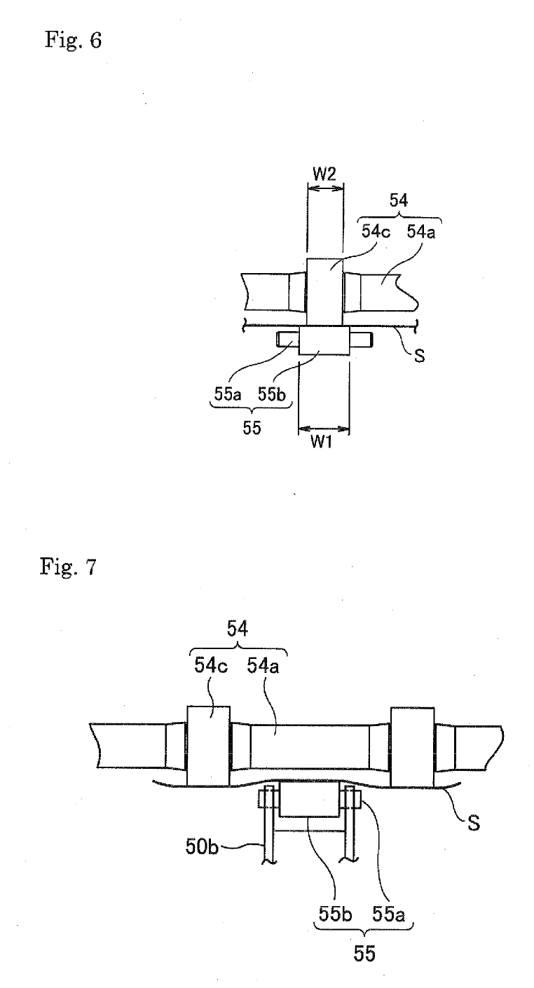

As shown in FIG. 6, the width W1 of the cylinder member 55b may be set to be larger than the width W2 of the roller body 54c of the driving roller 54, so that the cylinder member 55b is in pressing contact with the driving roller 54 within the range of the whole width of the cylinder member 55b.

According to the structure, an edge portion of the cylinder member 55b is not in pressing contact with the roller body 54c of the driving roller 54. Even when the image formed surface of the sheet S is opposed to the driven roller 55, therefore, a phenomenon that a contact mark of the edge appears in an image can be prevented from occurring, and the image is not damaged.

As shown in FIG. 7, the cylinder member 55b may be placed at a non-contact position which is shifted in the axial direction with respect to the roller body 54c of the driving roller 54, and at a position where the outer peripheral surface of the cylinder member 55b overlaps with that of the roller body 54c as seen in the axial direction.

When the driving roller 54 and the driven roller 55 are in this positional relationship, the conveyed sheet S has a gently wavy shape as seen in the sheet conveying direction D, and hence the conveying posture is stabilized.

The invention is not restricted to the configuration where the driven roller 55 is directly rotated by the rotational force of the driving roller 54 as described above, and may have a structure where the driven roller 55 is indirectly rotated via the sheet S which is conveyed by the rotational force of the driving roller 54.

In the above, the case where the driven roller 55 is disposed in (downstream of) the fixing device 25 in the form where the roller is in pressing contact with the driving roller 54 has been described. The installation form and place of the driven roller 55 are not restricted to them. Namely, the driven roller 55 may not be in the form where it is drivenly rotated by the driving roller 54, and the installation place is not particularly restricted as far as the place is in the sheet conveying path extending from the sheet feeding device 40 to the discharge tray 27.

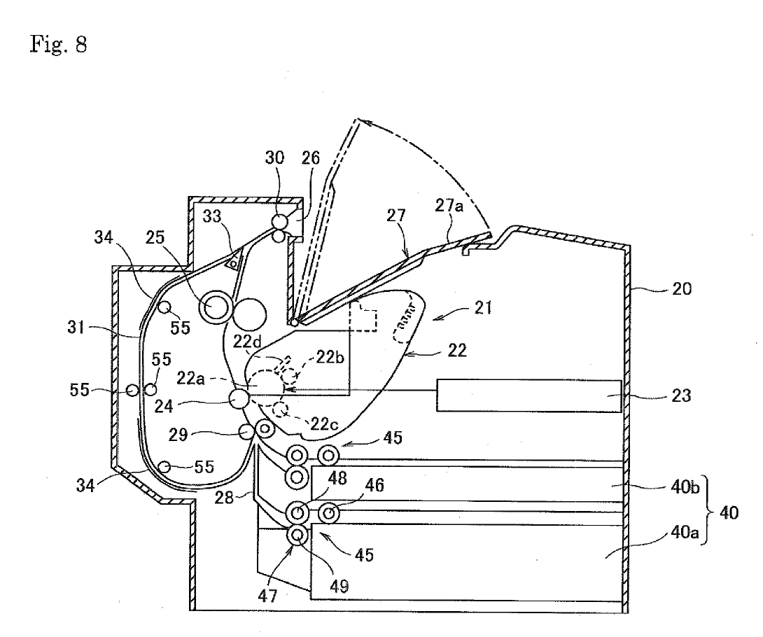

As shown in FIG. 8, for example, a chute 34 which guides the sheet S may be disposed in the sheet conveying path such as the inversion path 31, and the driven roller 55 may be placed at a position opposed to the chute 34. Alternatively, as shown in the figure, two driven rollers 55 may be placed in the sheet conveying path so as to be opposed to each other.

In these cases, the driven roller(s) 55 is drivenly rotated by the conveyed sheet S.

When the above-described driven roller 55 which has a longer life, and which is economical is attached to an image forming apparatus, the replacement frequency of the driven roller 55 can be reduced, and moreover the cost of the apparatus can be lowered.

In the case where the image forming apparatus includes the fixing device 25 which fixes a toner image to the sheet S by means of thermocompression bonding with using the heating roller 52 and the pressing roller 53 as in the exemplary embodiment, particularly, toner contamination can be effectively avoided by disposing the driven roller 55 in which the above-mentioned fluororesin is used as the cylinder member 55b, downstream of the fixing station P of the fixing device 25 in the sheet conveying direction D.

In the above, the case where a sheet conveying device including the driven rotary unit for conveying a sheet according to the invention is attached to an image forming apparatus which performs the toner recording process has been described. The driven rotary unit can be applied to various sheet conveying devices used in, for example, an image forming apparatus of the inkjet type in which recording is performed by an ejected ink, and an ATM (Automated Teller Machine).

As the sheet to be conveyed, various sheet-like materials such as a paper sheet, a film, a postcard, or a bill can be used.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A driven rotary unit for conveying a sheet, comprising:
a shaft member which is rotatably supported by a supporting member; and
a cylindrical cylinder member which is attached to an outside of the shaft member, in which an inner diameter of the cylinder member is larger than an outer diameter of the shaft member, and which is disposed to be freely rotatable with respect to the shaft member,
wherein the driven rotary unit is rotated by a conveyed sheet.

2. A driven rotary unit for conveying a sheet, comprising:
a shaft member which is rotatably supported by a supporting member; and
a cylindrical cylinder member which is attached to an outside of the shaft member, in which an inner diameter of the cylinder member is larger than an outer diameter of the shaft member, and which is disposed to be freely rotatable with respect to the shaft member,
wherein the driven rotary unit is drivenly rotated by transmitting a rotational force of a driving rotary unit to the cylinder member, and cooperates with the driving rotary unit to convey a sheet.

3. The driven rotary unit for conveying a sheet according to claim 1, wherein the shaft member comprises:
a columnar holding portion to which the cylinder member is attached, and which holds the cylinder member; and
a supported portion which is coaxial with a rotation axis of the holding portion on both sides in an axial direction of the holding portion, which is smaller in diameter than the holding portion, and which is supported by the supporting member, and
the inner diameter of the cylinder member is larger than an outer diameter of the holding portion.

4. The driven rotary unit for conveying a sheet according to claim 2, wherein the shaft member comprises:
a columnar holding portion to which the cylinder member is attached, and which holds the cylinder member; and
a supported portion which is coaxial with a rotation axis of the holding portion on both sides in an axial direction of the holding portion, which is smaller in diameter than the holding portion, and which is supported by the supporting member, and
the inner diameter of the cylinder member is larger than an outer diameter of the holding portion.

5. The driven rotary unit for conveying a sheet according to claim 2, wherein the shaft member is supported by the supporting member while being urged by an elastic member toward the driving rotary unit.

6. The driven rotary unit for conveying a sheet according to claim 1, wherein the cylinder member is formed by a fluororesin.

7. The driven rotary unit for conveying a sheet according to claim 2, wherein the cylinder member is formed by a fluororesin.

8. The driven rotary unit for conveying a sheet according to claim 1, wherein at least one of outer and inner peripheral surfaces of the cylinder member is coated with a fluororesin.

9. The driven rotary unit for conveying a sheet according to claim 2, wherein at least one of outer and inner peripheral surfaces of the cylinder member is coated with a fluororesin.

10. The driven rotary unit for conveying a sheet according to claim 1, wherein the shaft member is made from a resin or a corrosion-resistant metal.

11. The driven rotary unit for conveying a sheet according to claim 2, wherein the shaft member is made from a resin or a corrosion-resistant metal.

12. The driven rotary unit for conveying a sheet according to claim 2, wherein
a width of the cylinder member is larger than a width of a body portion of the driving rotary unit, and
the cylinder member is relatively in pressing contact with the driving rotary unit in a range of a whole width of the cylinder member.

13. The driven rotary unit for conveying a sheet according to claim 2, wherein the cylinder member is placed at a non-contact position which is shifted in an axial direction with respect to a body portion of the driving rotary unit, and at a position where an outer peripheral surface of the cylinder member overlaps with an outer peripheral surface of the body portion as seen in the axial direction.

14. A sheet conveying device to which the driven rotary unit for conveying a sheet according to claims 2 is attached.

15. An image forming apparatus comprising: a fixing device including a fixing portion which fixes a toner image to a sheet by means of thermocompression bonding; and the sheet conveying device according to claim 10 attached downstream of the fixing portion in a sheet conveying direction.
